(19) United States
(12) Patent Application Publication
(10) Pub. No.: US 2008/0136801 A1
(43) Pub. Date: Jun. 12, 2008

(54) Liquid crystal display and driving method thereof

(75) Inventor: De-Ching Shie, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/001,550

(22) Filed: Dec. 11, 2007

(30) Foreign Application Priority Data
Dec. 11, 2006 (TW) 95146223

(51) Int. Cl. G06F 3/038; G09G 3/36

(52) U.S. Cl. 345/204; 345/87; 345/92

(57) ABSTRACT

An exemplary liquid crystal display (2) includes a first substrate (21) having a plurality of common electrodes, parallel to each other, formed thereat; a second substrate (22) opposite to the first substrate, a liquid crystal layer (23) sandwiched between the first and second substrates. The second substrate has a plurality of scanning lines (221) that are parallel to each other and that each extend along a first direction; and a plurality of signal lines (222) that are parallel to each other and that each extend along a second direction orthogonal to the first direction. The plurality of common electrodes corresponds to the plurality of scanning lines or the plurality of signal lines.

### FIELD OF THE INVENTION

The present invention relates to liquid crystal displays (LCDs), and particularly to an active matrix LCD which is suitable for motion picture display and a driving method for driving the LCD.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace cathode ray tube (CRT) monitors and televisions.

FIG. 10 is a schematic, side view of a typical LCD, and FIG. 11 is an abbreviated circuit diagram of the typical LCD. The LCD 10 includes a first glass substrate 11, a second glass substrate 12 facing the first substrate 11, a liquid crystal layer 13 sandwiched between the first and second substrates 11, 12. A common electrode layer 15 is provided at an inner surface of the first substrate 11, adjacent to the liquid crystal layer 13, which is generally made from indium-tin oxide (ITO).

The second substrate 12 includes a number n (where n is a natural number) of scanning lines 121 that are parallel to each other and that each extend along a first direction, and a number k (where k is also a natural number) of signal lines 1224 that are parallel to each other and that each extend along a second direction orthogonal to the first direction. The second substrate 12 also includes a plurality of thin film transistors (TFTs) 123 that function as switching elements. The second substrate 12 further includes a plurality of pixel electrodes 17 formed on a surface thereof facing the first substrate 11. Each TFT 123 is provided in the vicinity of a respective point of intersection of the scanning lines 121 and the signal lines 122.

Each TFT 123 includes a gate electrode, a source electrode, and a drain electrode. The gate electrode of the TFT 123 is connected to the corresponding scanning line 121. The source electrode of the TFT 123 is connected to the corresponding signal line 122. The drain electrode of the TFT 123 is connected to a corresponding pixel electrode 17.

The plurality of pixel electrodes 17, the common electrode layer 15 facing the pixel electrode 17, and liquid crystal molecules of the liquid crystal layer sandwiched between the two electrodes 15, 17 cooperatively define a plurality of pixel units.

The scanning lines 121 are connected to a scanning line driving circuit 124. The signal lines 122 are connected to a signal line driving circuit 125.

FIG. 12 is an abbreviated timing chart illustrating operation of the LCD 10. Scanning signals G1-Gn are generated by the scanning line driving circuit 124, and are applied to the scanning lines 121. Gradation voltages (Vn) are generated by the signal line driving circuit 125, and are sequentially applied to the signal lines 122. A common voltage (Vcom) is applied to all the common electrodes. Only one scanning signal pulse is applied to each scanning line 121 during each frame, the scanning signal pulse having a duration which is equal to a period of clock pulses of a scanning clock signal. The scanning signal pulses are output sequentially to the scanning lines 121.

The scanning line driving circuit 124 sequentially provides scanning pulses (G1 to Gn) to the scanning lines 121, and activates the TFTs 123 respectively connected to the scanning lines 121. When the scanning lines 121 are thus scanned, the signal line driving circuit 125 outputs gradation voltages Vn corresponding to the image data to the signal lines 122. Then the gradation voltages are applied to the pixel electrodes 17 via the activated TFTs 123. The potentials of the common electrode 15 are set at a uniform potential. The gradation voltages Vn written to the pixel electrodes 17 are used to control the amount of light transmission at the corresponding pixel units. Consequently, the pixel units cooperatively provide an image for display on a screen of an LC panel 10 of the LCD 100.

FIG. 13 is a schematic explanatory view illustrating the polarities of the voltages of the pixel units in the case there the row inversion mode is employed. Here, the image signals are written into the pixel electrode 17 such that the pixel units in the same scanning lines 121 have the same polarities of the voltages, the adjacent pixel units in the data lines 122 have the alternated polarities of the voltages, and the polarities of the voltages of the pixels are alternated every one frame. As a result, a row inversion mode is realized.

The gradation voltage Vn is a signal whose strength varies in accordance with each piece of image data, whereas the common voltage Vcom is a signal that has a constant value which does not vary at all. However, only one potential can be provided to the common electrode 15 at one point, and the polarity of the voltage should be alternated after one scanning line 121 is scanned. The common voltage and the data signal provided thereon influence the voltage applied to the liquid crystal layer 13 of the pixel unit. Thus, the polarity change of the common voltage would take detrimental effect to the pixel units that are not scanned and produce display distortion. In addition, the high frequency polarity change of the common voltage would produce a high electrical power consumption.

What is needed, therefore, is an LCD that can overcome the above-described deficiencies.

### SUMMARY

In one embodiment, an exemplary liquid crystal display includes a first substrate having a plurality of common electrodes, parallel to each other, formed thereat; a second substrate opposite to the first substrate, a liquid crystal layer sandwiched between the first and second substrates. The second substrate has a plurality of scanning lines that are parallel to each other and that each extend along a first direction; and a plurality of signal lines that are parallel to each other and that each extend along a second direction orthogonal to the first direction. The plurality of common electrodes corresponds to the plurality of scanning lines or the plurality of signal lines.

An exemplary method of driving the liquid crystal display includes the following steps: during one frame, providing a first common voltage to odd-numbered common electrodes, and providing a second common voltage to even-numbered common electrodes, and providing a first gradation voltage to the signal lines when the odd-numbered scanning lines are thus scanned, and providing a second gradation voltage to the signal lines when the even-numbered scanning lines are thus scanned; during a next frame, providing the second common voltage to odd-numbered common electrodes, and providing the first common voltage to even-numbered common electrodes, and providing the second gradation voltage to the signal lines when the odd-numbered scanning lines are thus scanned, and providing the first gradation voltage to the signal lines when the even-numbered scanning lines are thus scanned. The first common voltage is larger than the first gradation voltage, and the second common voltage is less than the second gradation voltage.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, isometric view of an LCD according to a first embodiment of the present invention, which has a first substrate and a second substrate, and a plurality of pixel units.

FIG. 2 is a plane view of the first substrate of FIG. 1.

FIG. 3 is a plane view of the second substrate of FIG. 1.

FIG. 4 is an abbreviated timing chart illustrating operation of the LCD of FIG. 1.

FIG. 5 is an explanatory view illustrating the polarities of the voltages of the plurality of pixel units in a row inversion mode.

FIG. 6 is a plane view of a first substrate of an LCD according to a second embodiment of the present invention.

FIG. 7 is a plane view of a second substrate of the LCD according to the second embodiment.

FIG. 8 is an abbreviated timing chart illustrating operation of the LCD of the second embodiment.

FIG. 9 is an explanatory view illustrating the polarities of the voltages of a plurality of pixel units in a column inversion mode of the second embodiment.

FIG. 10 is a side view of a conventional LCD, which has a second substrate and a plurality of pixel units.

FIG. 11 is a plane view of the second substrate of FIG. 10.

FIG. 12 is an abbreviated timing chart illustrating operation of the LCD of FIG. 10.

FIG. 13 is an explanatory view illustrating the polarities of the voltages of a plurality of pixel units in a row inversion mode of the LCD of FIG. 10.

### DETAILED DESCRIPTION OF PREFERRED EMBODIMENTS

Reference will now be made to the drawings to describe various embodiments of the present invention in detail.

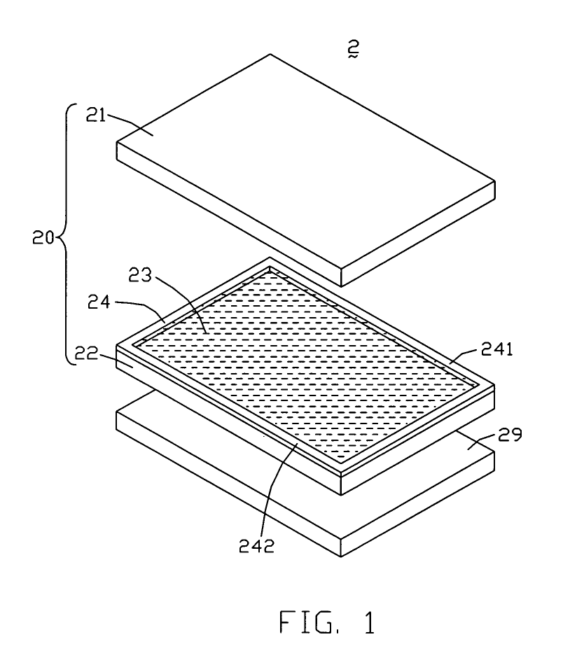

In FIG. 1, an LCD 2 according to a first embodiment of the present invention includes a liquid crystal panel 20, and a backlight module 29 provided under the liquid crystal panel 20. The liquid crystal panel 20 includes a first substrate 21, a second substrate 22 facing the first substrate 21, and a liquid crystal layer 23 sandwiched between the first and second substrates 21, 22 by a sealant 24.

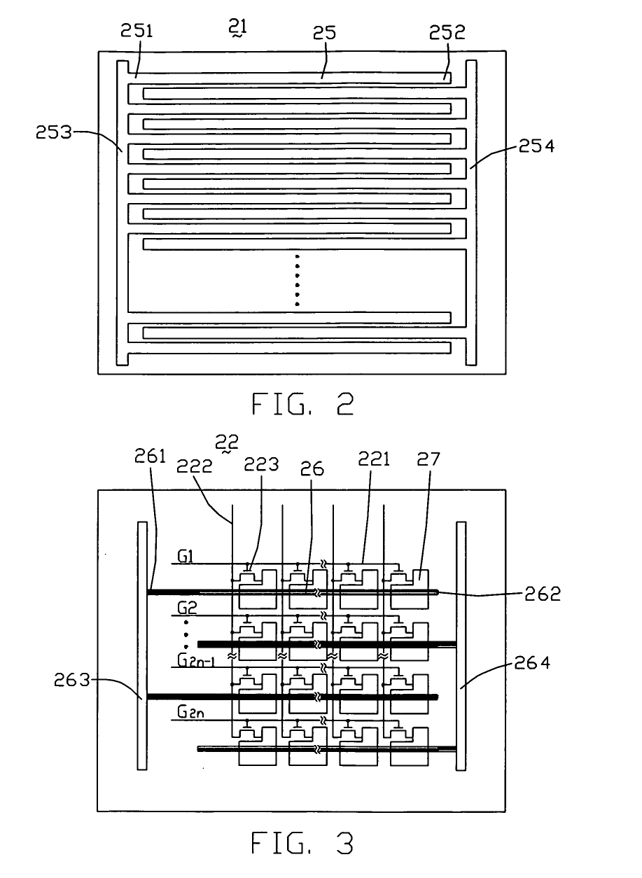

Referring to FIG. 2, a plane view of the first substrate 21 is shown. The first substrate 21 has a plurality of parallel strip-shaped common electrodes 25, which are made from Indium Tin Oxide (ITO). Each common electrode 25 has a first end 251 and a second end 252 opposite to the first end 251. The first ends 251 of odd-numbered common electrodes 25 are electrically connected to a first common electrode bus line 253, and the second ends 252 of even-numbered common electrodes 25 are electrically connected to a second common electrode bus line 254.

Referring to FIG. 3, a plane view of the second substrate 22 is shown. The second substrate 22 includes a number n (where n is a natural number) of scanning lines 221 that are parallel to each other and that each extend along a first direction, and a number k (where k is also a natural number) of signal lines 222 that are parallel to each other and that each extend along a second direction orthogonal to the first direction, and a number n (where n is a natural number) of common electrode lines 26 that are parallel to each other and that each extend along the first direction, parallel to the scanning lines 221. The second substrate 22 also includes a plurality of TFTs 223 that function as switching elements. The second substrate 22 further includes a plurality of pixel electrodes 27 formed on a surface thereof facing the second substrate 22. The scanning lines 221 are connected to a scanning line driving circuit (not shown). The signal lines 222 are connected to a signal line driving circuit (not shown). Each TFT 223 is provided in the vicinity of a respective point of intersection of the scanning lines 221 and the signal lines 222. One pixel electrode 27, one common electrode 25 facing the pixel electrode 27, and liquid crystal molecules of the liquid crystal layer 23 sandwiched between the two electrodes 27, 25 cooperatively define a single pixel unit, and form a liquid crystal capacitor Cls (not shown). Each pixel unit defines a minimum display unit.

Each TFT 223 includes a gate electrode, a source electrode, and a drain electrode. The gate electrode of the TFT 223 is connected to the corresponding scanning line 221. The source electrode of the TFT 223 is connected to the corresponding signal line 222. The drain electrode of the TFT 223 is connected to a corresponding pixel electrode 27.

Each common electrode line 26 is parallel to the common electrode 25, which has a first end 261 and a second end 262. The first ends 261 of odd-numbered common electrode lines 26 are electrically connected to a first common bus line 263, and the second ends 262 of even-numbered common electrode lines 26 are electrically connected to a second common bus line 264. Each common electrode line 26 is insulated to the corresponding pixel electrode 27, and the common electrode line 26 and the corresponding pixel electrode 27 and the insulator (not shown) therebetween define a storage capacitor (not shown).

The sealant 24 has a first conductive portion 241 and a second conductive portion 242 opposite to the first conductive portion 241. The first and the second conductive portions 241, 242 are insulated with each other. After assembling the first and the second substrates 21, 22, the first conductive portion 241 electrically connect the first common electrode bus line 253 and the first common bus line 263, and the second conductive portion 242 electrically connect the second common electrode bus line 254 and the second common bus line 264.

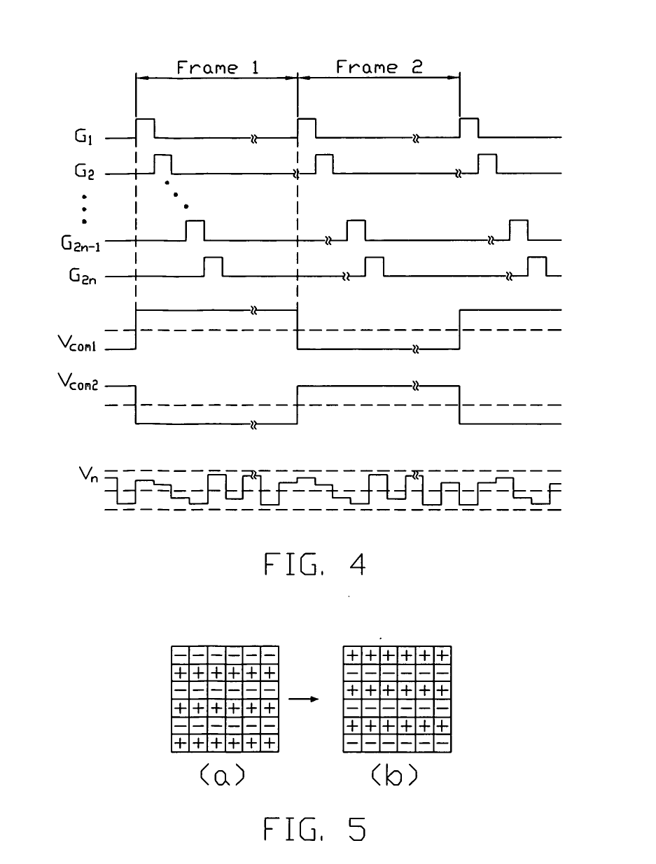

FIG. 4 is an abbreviated timing chart illustrating a driving method of the LCD 2. Scanning signals G1-Gn are generated by the scanning line driving circuit, and are applied to the scanning lines 221. Gradation voltages (Vn) are generated by the signal line driving circuit, and are sequentially applied to the signal lines 222. The even-numbered common electrode 25 and the odd-numbered common electrode 25 are respectively provided voltages having opposite polarities and constant potential in one frame. And, the polarities of the even-numbered common electrode 25 and the odd-numbered common electrode 25 are respectively alternated in next frame. Only one scanning signal pulse is applied to each scanning line 221 during each frame, the scanning signal pulse having a duration that is equal to a period of the clock pulses of a scanning clock signal. The scanning signal pulses are output sequentially to the scanning lines 221 to activate the TFTs 223 respectively connected to the scanning lines 221.

During Frame 1, when the odd-numbered scanning lines 221 are thus scanned, the signal line driving circuit outputs a first gradation voltages Vn corresponding to the image data to the signal lines 222. Then the first gradation voltages are applied to the pixel electrodes 27 via the activated TFTs 223. The odd-numbered common electrodes 25 are provided with the first common voltage. The common voltage of the common electrode 25 and the gradation voltage of the pixel electrode 27 cooperate to define a first display voltage, which is used to control the amount of light transmission at the corresponding pixel units. The first common voltage has positive polarity and is larger than the first gradation voltage. Thus, the first display voltage is a negative polarity display voltage.

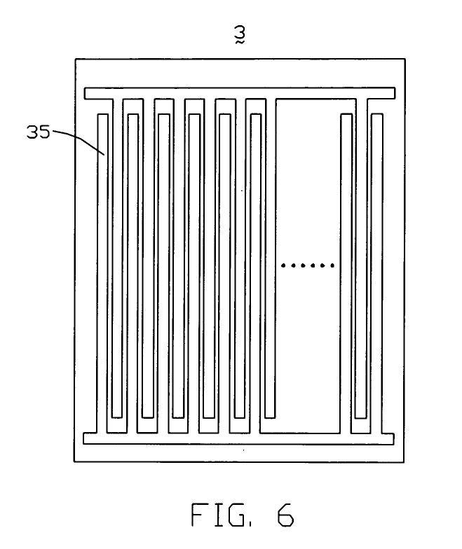

In the frame 1, when the even-numbered scanning lines 221 are thus scanned, the signal line driving circuit outputs a second gradation voltages Vn corresponding to the image data to the signal lines 222. Then the second gradation voltages are applied to the pixel electrodes 27 via the activated TFTs 223. The even-numbered common electrodes 25 are provided with the second common voltage. The common voltage of the common electrode 25 and the gradation voltage of the pixel electrode 27 cooperate to define a second display voltage, which is used to control the amount of light transmission at the corresponding pixel units. The second common voltage has negative polarity and is less than the second gradation voltage. Thus, the pixel units corresponding to the even-numbered scanning lines 221 have a positive polarity display voltage. At the same time, the two electrodes of the liquid crystal capacitor is the pixel electrode 27 and the common electrode 25, and the electrodes of the storage capacitor is the pixel electrode 27 and the common electrode line 26 electrically connected to the common electrode 25. Therefore, the display voltage is respectively provided to the liquid crystal capacitor and the storage capacitor. After each scanning line 221 is scanned, the TFTs 223 connected to the scanning lines 221 are turned off, and the display voltages still be kept by the liquid crystal capacitor and the storage capacitor in this frame. FIG. 5 (a) shows the polarities of the display voltages of the pixel units in the Frame 1.

During Frame 2, when the odd-numbered scanning lines 221 are thus scanned, the signal line driving circuit outputs the second gradation voltages Vn corresponding to the image data to the signal lines 222. Then the second gradation voltages are applied to the pixel electrodes 27 via the activated TFTs 223. The odd-numbered common electrodes 25 are provided with the second common voltage. The common voltage of the common electrode 25 and the gradation voltage of the pixel electrode 27 cooperate to define the second display voltage, which is a positive polarity display voltage. And, when the even-numbered scanning lines 221 are thus scanned, the signal line driving circuit outputs first gradation voltages Vn corresponding to the image data to the signal lines 222. Then the first gradation voltages are applied to the pixel electrodes 27 via the activated TFTs 223. The even-numbered common electrodes 25 are provided with the first common voltage. The common voltage of the common electrode 25 and the gradation voltage of the pixel electrode 27 cooperate to define the first display voltage, which is a negative polarity display voltage. FIG. 5 (b) shows the polarities of the display voltages of the pixel units in the frame 2.

In operation, the even-numbered common electrode 25 and the odd-numbered common electrode 25 are respectively provided voltages having opposite polarities and constant potential in one frame. And, the polarities of the even-numbered common electrode 25 and the odd-numbered common electrode 25 are respectively alternated in continuous two frames. Thus, a row inversion display mode can be realized under the cooperation of the gradation voltage of the pixel electrode 27, as shown in FIG. 5. Here, the image signals are written into the pixel electrode 27 such that the pixel units in the same scanning lines 221 have the same polarities of the voltages, the adjacent pixel units in the data lines 222 have the alternated polarities of the voltages, and the polarities of the voltages of the pixels are alternated every one frame. As a result, a row inversion mode is realized.

Comparing to the conventional LCD, the LCD 2 utilizes the plurality of common electrodes 25 to realize providing two opposite polarities voltages to the common electrodes 25 at one point. Thus, the LCD 2 can be operated by more different driving methods. In addition, the polarity of each common electrode 25 keeps unchanging in one frame, which assures the display voltage provided to each pixel units keeping unchanging in one frame. Moreover, the polarity alternation of each common electrode 25 only produces at the start of next frame. Therefore, the alternation frequency is largely brought down, which can reduce the electrical power consumption and reduces the high frequency interference.

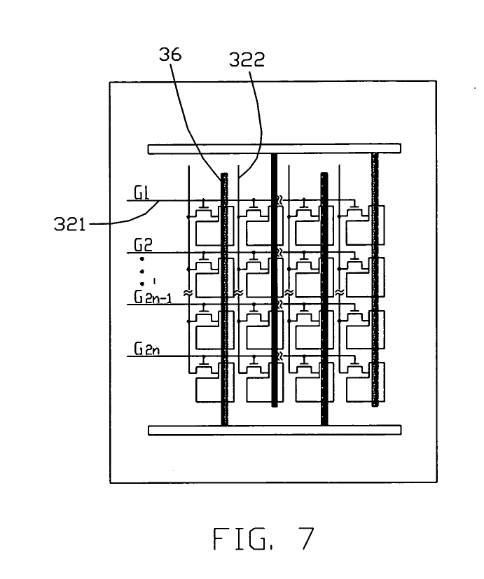

In FIG. 6 and FIG. 7, a first and a second substrates of an LCD 3 according to a second embodiment of the present invention is shown, which has a same structure to that of the LCD 2 of the first embodiment except that a plurality of common electrode 35 and a plurality of common electrode line 36 are disposed perpendicular to a plurality of scanning lines 321.

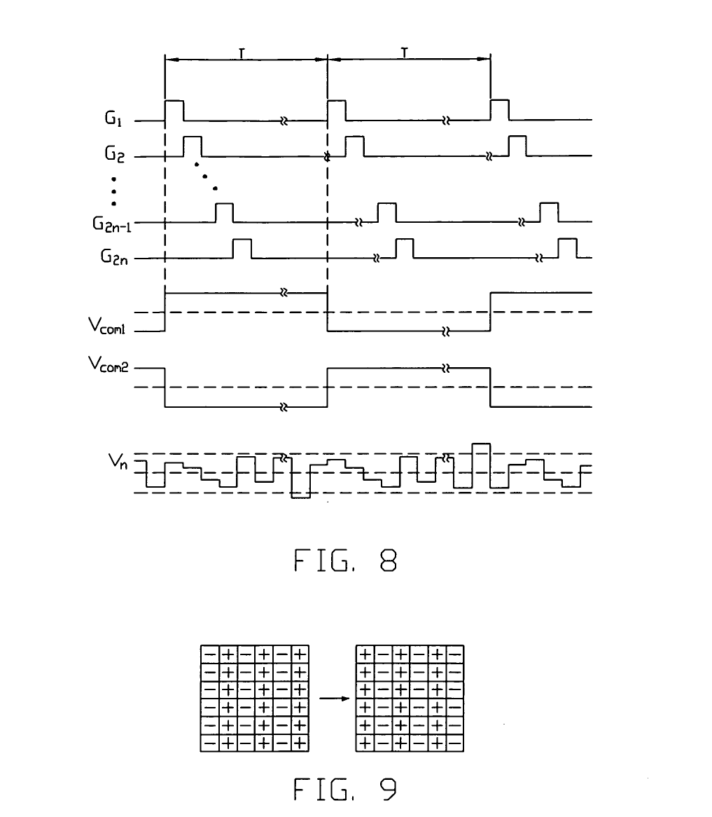

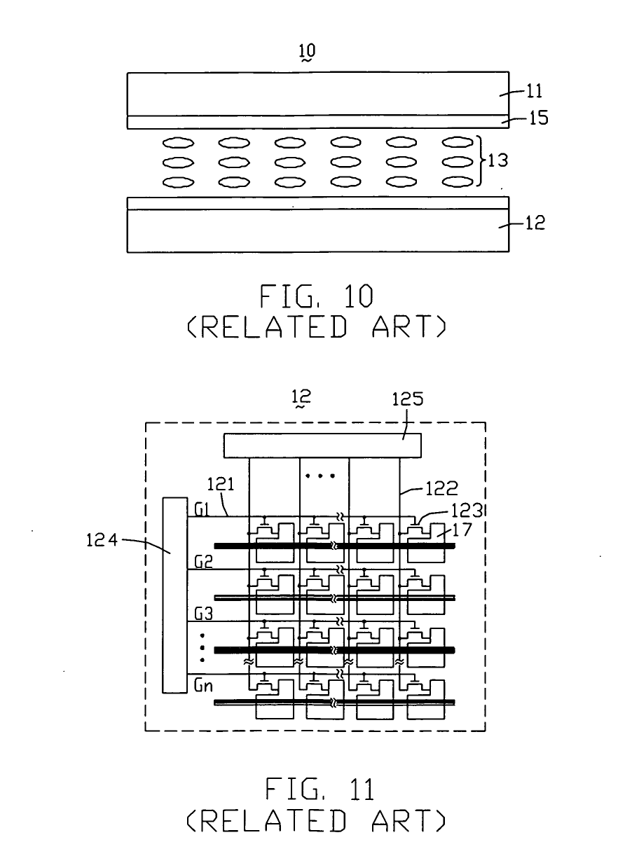

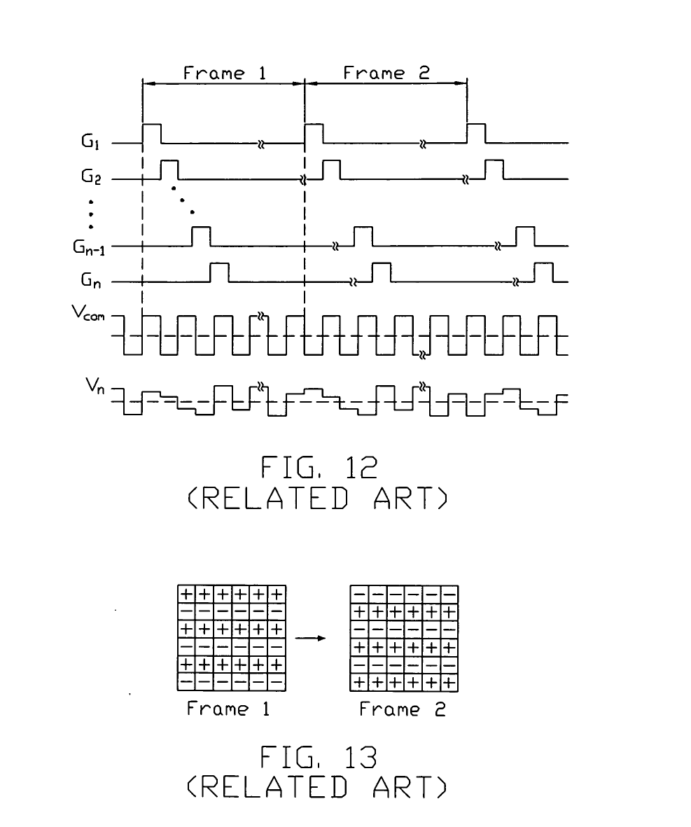

FIG. 8 is an abbreviated timing chart illustrating operation of the LCD 3. Scanning signals G1-Gn are generated by the scanning line driving circuit, and are applied to the scanning lines 321. Gradation voltages (Vn) are generated by the signal line driving circuit, and are sequentially applied to the signal lines 322. The even-numbered common electrode 35 and the odd-numbered common electrode 35 are respectively provided voltages having opposite polarities and constant potential in one frame. And, the polarities of the even-numbered common electrode 35 and the odd-numbered common electrode 35 are respectively alternated in next frame. Only one scanning signal pulse is applied to each scanning line 321 during each frame, the scanning signal pulse having a duration that is equal to a period of the clock pulses of the scanning clock signal. The scanning signal pulses are output sequentially to the scanning lines 321 to activate the TFTs respectively connected to the scanning lines 321.

During Frame 1, when the scanning lines 321 are sequentially scanned, the signal line driving circuit outputs a first gradation voltages Vn corresponding to the image data to the odd-numbered signal lines 322. Then the first gradation voltages are applied to the pixel electrodes in odd-number column, corresponding to the odd-numbered signal lines 322, through the activated TFTs. The odd-numbered common electrodes 35 are provided with the first common voltage. The common voltage of the common electrode 35 and the gradation voltage of the pixel electrode cooperate to define a first display voltage, which is used to control the amount of light transmission at the corresponding pixel units. The first common voltage has positive polarity and is larger than the first gradation voltage. Thus, the first display voltage applied to the pixel electrodes in odd-number column is a negative polarity display voltage. At the same time, the signal line driving circuit outputs a second gradation voltages Vn corresponding to the image data to the even-numbered signal lines 322. Then the second gradation voltages are applied to the pixel electrodes in even-number column, corresponding to the even-numbered signal lines 322, through the activated TFTs. The even-numbered common electrodes 35 are provided with the second common voltage. The common voltage of the common electrode 35 and the gradation voltage of the pixel electrode cooperate to define a second display voltage, which is used to control the amount of light transmission at the corresponding pixel units. The second common voltage has negative polarity and is less than the second gradation voltage. Thus, the first display voltage applied to the pixel electrodes in even-number column is a positive polarity display voltage.

During Frame 2, when the scanning lines 321 are sequentially scanned, the signal line driving circuit outputs the second gradation voltages Vn corresponding to the image data to the odd-numbered signal lines 322. Then the second gradation voltages are applied to the pixel electrodes in odd-number column, corresponding to the odd-numbered signal lines 322, through the activated TFTs. The odd-numbered common electrodes 35 are provided with the second common voltage. Thus, the positive second display voltage is applied to the pixel electrodes in odd-number column. At the same time, the signal line driving circuit outputs a first gradation voltages Vn corresponding to the image data to the even-numbered signal lines 322. Then the first gradation voltages are applied to the pixel electrodes in even-number column, corresponding to the even-numbered signal lines 322, through the activated TFTs. The even-numbered common electrodes 35 are provided with the first common voltage. Thus, the negative first display voltage is applied to the pixel electrodes in even-number column.

In operation, the even-numbered common electrode 35 and the odd-numbered common electrode 35 are respectively provided voltages having opposite polarities and constant potential in one frame. And, the polarities of the even-numbered common electrode 35 and the odd-numbered common electrode 35 are respectively alternated in continuous two frames. Here, the image signals are written into the pixel electrode such that the pixel units in the same column have the same polarities of the voltages, the adjacent pixel units in the same scanning line 321 have the alternated polarities of the voltages, and the polarities of the voltages of the pixels are alternated every one frame. As a result, a column inversion mode is realized.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A liquid crystal display comprising:
a first substrate comprising a plurality of common electrodes, parallel to each other, formed thereat;
a second substrate opposite to the first substrate comprising:
a plurality of scanning lines that are parallel to each other and that each extend along a first direction; and
a plurality of signal lines that are parallel to each other and that each extend along a second direction orthogonal to the first direction; and
a liquid crystal layer sandwiched between the first and second substrates;
wherein the plurality of common electrodes correspond to the plurality of scanning lines or the plurality of signal lines.

2. The liquid crystal display as claimed in claim 1, wherein the common electrode is disposed parallel to the scanning lines.

3. The liquid crystal display as claimed in claim 1, wherein the common electrode is disposed parallel to the signal lines.

4. The liquid crystal display as claimed in claim 1, wherein each common electrode comprises a first end and a second end, and the first ends of the odd-numbered common electrodes being electrically connected, and second ends of the even-numbered common electrodes being electrically connected.

5. The liquid crystal display as claimed in claim 4, wherein the second substrate further comprises a plurality of common electrode lines corresponding to the plurality of common electrodes, each common electrode line comprising a first end and a second end, and the first ends of the odd-numbered common electrode lines being electrically connected, and second ends of the even-numbered common electrode lines being electrically connected.

6. The liquid crystal display as claimed in claim 5, further comprising a sealant, which comprises a first conductive portion and a second conductive portion insulated with the first conductive portion, the first conductive portion electrically connecting the odd-numbered common electrodes and the odd-numbered common electrode lines; and the second conductive portion electrically connecting the even-numbered common electrodes and the even-numbered common electrode lines.

7. The liquid crystal display as claimed in claim 6, further comprising a plurality of TFT provided in the vicinity of a respective point of intersection of the scanning lines and the signal lines, and a plurality of pixel electrodes connected to the TFT.

8. The liquid crystal display as claimed in claim 7, wherein the pixel electrode is insulated to the corresponding common electrode line, which define a storage capacitor with an insulator between the pixel electrode and the corresponding common electrode line.

9. A method of driving the liquid crystal display in claim 1, the method comprising:
during one frame, providing a first common voltage to odd-numbered common electrodes, and providing a second common voltage to even-numbered common electrodes, and providing a first gradation voltage to the signal lines when the odd-numbered scanning lines are thus scanned, and providing a second gradation voltage to the signal lines when the even-numbered scanning lines are thus scanned;
during a next frame, providing the second common voltage to odd-numbered common electrodes, and providing the first common voltage to even-numbered common electrodes, and providing the second gradation voltage to the signal lines when the odd-numbered scanning lines are thus scanned, and providing the first gradation voltage to the signal lines when the even-numbered scanning lines are thus scanned; and
wherein the first common voltage is larger than the first gradation voltage, and the second common voltage is less than the second gradation voltage.

10. The method as claimed in claim 9, wherein the first common voltage is positive voltage, and the second common voltage is negative voltage.

11. The method as claimed in claim 9, wherein the two steps are repeated.

12. A method of driving the liquid crystal display in claim 1, the method comprising:
during a frame, when the scanning lines are sequentially scanned, providing a first gradation voltage to odd-numbered signal lines; and providing a first common voltage to odd-numbered common electrodes; and providing a second gradation voltage to even-numbered signal lines; and providing a second common voltage to even-numbered common electrodes; and
during a next frame, when the scanning lines are sequentially scanned, providing the second gradation voltage to odd-numbered signal lines; and
providing the second common voltage to odd-numbered common electrodes;
and providing the first gradation voltage to even-numbered signal lines; and
providing the first common voltage to even-numbered common electrodes;
wherein the first common voltage is larger than the first gradation voltage, and the second common voltage is less than the second gradation voltage.

13. The method as claimed in claim 12, wherein the first common voltage is positive voltage, and the second common voltage is negative voltage.

14. The method as claimed in claim 12, wherein the two steps are repeated.
